(19) United States
(12) Patent Application Publication
(10) Pub. No.: US 2026/0178891 A1
(43) Pub. Date: Jun. 25, 2026

(54) NEURAL NETWORK OPTIMIZATION FOR RESOURCE CONSTRAINED DEVICE DEPLOYMENT

(71) Applicant: Snap Inc., Santa Monica, CA (US)

(72) Inventors: Yerlan Idelbayev, Los Angeles, CA (US); Aleksei Lebedev, Playa Vista, CA (US); Pavlo Chemerys, New York, NY (US); Ju Hu, Los Angeles, CA (US); Dhritiman Sagar, New York, NY (US); Jian Ren, Hermosa Beach, CA (US)

(21) Appl. No.: 18/990,732

(22) Filed: Dec. 20, 2024

(51) Int. Cl. G06N 3/0495

(52) U.S. Cl. CPC G06N 3/0495

(57) ABSTRACT

Described herein are systems and methods for optimizing neural network models for deployment on resource-constrained computing devices through layer-specific quantization. An original neural network model and deployment constraints are received as inputs. The optimization process alternates between a learning phase that updates model weights using task-specific loss functions and a compression phase that determines optimal bitwidth allocations for each layer through multiple-choice knapsack optimization. The compression phase computes quantization errors for different bitwidth options per layer and selects optimal bitwidth combinations while satisfying deployment constraints. The process iteratively updates a penalty parameter and continues until convergence, producing an optimized neural network model with quantized weights and layer-specific bitwidth allocations that maintains performance while meeting size, computational, and latency constraints for the target device.

### TECHNICAL FIELD

The present disclosure relates generally to neural network optimization technologies, and more particularly to systems and methods for efficiently deploying neural network models on resource-constrained computing devices. Specifically, the subject matter described herein pertains to layer-specific quantization techniques that optimize neural network models by determining optimal bitwidth allocations across network layers while maintaining model performance, enabling deployment of large neural networks on mobile and edge devices with limited memory and computational resources.

### BACKGROUND

Neural networks have become increasingly prevalent across a wide range of applications and computing platforms. These sophisticated machine learning models are now being deployed across diverse computing environments, from powerful cloud-based servers to resource-constrained mobile and edge devices. The expansion of neural network applications has been particularly notable in the mobile computing space, where neural networks are being integrated into smartphones, tablets, wearable computing devices, and other portable devices to enable advanced features such as image recognition, natural language processing, and real-time data analysis.

As neural networks continue to evolve and improve in capability, they have generally grown larger and more complex, requiring significant computational resources and memory storage. These models are typically trained using high-precision floating-point representations (e.g., FP16/FP32) that enable precise calculations and optimal model performance.

The deployment landscape for neural networks has expanded beyond traditional computing environments to include a diverse ecosystem of edge devices and mobile platforms. These devices, while increasingly powerful, still operate under various hardware constraints, including limited on-chip memory, restricted computational capabilities, and power consumption considerations. The widespread adoption of neural networks in mobile and edge computing applications has created a growing need for efficient deployment strategies that can maintain model performance while operating within the practical limitations of target devices. This has led to increased focus on various optimization techniques for neural network deployment across different computing platforms.

### BRIEF DESCRIPTION OF THE DRAWINGS

In the drawings, which are not necessarily drawn to scale, like numerals may describe similar components in different views. To easily identify the discussion of any particular element or operation, the most significant digit or digits in a reference number refer to the figure number in which that element is first introduced. Some non-limiting examples are illustrated in the figures of the accompanying drawings in which:

FIG. 1 is a diagram illustrating a neural network model architecture showing multiple layers including an input layer, hidden layers, and an output layer, with interconnecting weights between the layers, consistent with some embodiments.

FIG. 2 is a system diagram depicting the flow of a neural network model through an optimization process, showing an original neural network model and deployment constraints being input to a neural network optimization system, which outputs an optimized model for deployment through a deployment service to a target computing device, consistent with some embodiments.

FIG. 3 is a flowchart illustrating a method for optimizing a neural network model, including steps for receiving the model, initializing optimization, executing learning and compression phases, and storing the optimized model, consistent with some embodiments.

FIG. 4 is a block diagram illustrating a software architecture of a computing device, showing various applications, frameworks, and system components that may be used to implement aspects of the neural network optimization system, consistent with some embodiments.

FIG. 5 is a block diagram illustrating a hardware architecture of a computing device, including processors, memory, storage, and I/O components that may be used to implement the neural network optimization system, consistent with some embodiments.

### DETAILED DESCRIPTION

The present disclosure relates to techniques for optimizing neural network models for deployment on resource-constrained computing devices through layer-specific quantization. The following detailed description is presented to enable any person skilled in the art to make and use the disclosed embodiments. For purposes of explanation, specific details are set forth describing systems and methods for determining optimal bitwidth allocations across neural network layers while maintaining model performance within specified deployment constraints. However, it will be apparent to one skilled in the art that the present embodiments may be practiced without these specific details.

The disclosed embodiments provide techniques for optimizing neural network models through a layer-specific quantization approach that enables deployment on resource-constrained computing devices. The system takes an original neural network model and deployment constraints (including storage size, computational operations, and latency targets) as inputs, and employs an iterative two-phase optimization process: a learning phase that updates model weights using task-specific loss functions, and a compression phase that determines optimal bitwidth allocations for each layer using multiple-choice knapsack optimization. This process continues until the neural network model converges to a solution that simultaneously maintains task performance while satisfying the specified deployment constraints for the target device, effectively enabling sophisticated neural networks to run on devices with limited resources.

Neural network models have become increasingly sophisticated and complex, requiring substantial computational resources and memory storage. Traditional neural networks are typically trained using high-precision floating-point representations (e.g., FP16/FP32), resulting in large model sizes that exceed the practical limitations of mobile device memory and processing capabilities. When deploying these models on mobile devices, including mobile phones and wearable computing devices, such as augmented reality glasses, “smart watches” and other edge devices, developers face significant technical challenges due to the limited resources available on these target devices.

Existing approaches to model compression often rely on simple quantization techniques that apply uniform compression across all layers of the neural network. However, these approaches face significant technical limitations—because applying the same quantization level across all layers fails to account for the varying sensitivity and importance of different layers to the model's overall performance.

Additionally, traditional quantization methods struggle with the discrete nature of quantization operations, which makes it difficult to maintain model accuracy while reducing model size. This is particularly challenging because quantization is a discrete operation that does not take gradients, making it hard to optimize directly using conventional neural network training techniques.

Furthermore, current solutions lack a systematic way to determine optimal compression levels for each layer while simultaneously considering both model performance and deployment constraints. The problem becomes exponentially complex when considering that with “K” possible bitwidth choices and “L” layers, there are “K” to the “L-th” power possible combinations to evaluate. This creates a hard combinatorial optimization problem that cannot be effectively solved using conventional optimization techniques.

Accordingly, previous attempts to address this challenge have failed to provide a comprehensive solution that can automatically determine layer-specific quantization parameters while maintaining model performance within specified deployment constraints.

The disclosed embodiments overcome the limitations of traditional quantization approaches by implementing a novel two-phase optimization process that enables layer-specific quantization of neural network models. Unlike prior solutions that apply uniform compression across all layers, this approach recognizes that different layers of a neural network may have varying sensitivities to quantization and different impacts on overall model performance, allowing for optimal compression while preserving model functionality and overall quality of performance.

The learning phase of the optimization process maintains model performance by updating weights using task-specific loss functions while incorporating a penalty term based on differences between weight parameters and their quantized versions. This approach effectively addresses the challenge of discrete quantization operations by creating a continuous optimization problem that can be solved using conventional neural network training techniques, providing a significant advantage over traditional methods that struggle with discrete quantization operations.

The compression phase employs a sophisticated multiple-choice knapsack optimization technique that determines optimal bitwidth allocations across layers while satisfying deployment constraints. A multiple choice knapsack optimization problem (MCKP) is a computational optimization problem wherein a finite set of items, each associated with a specific weight and value, is divided into mutually exclusive groups or classes. The objective is to select exactly one item from each class such that the total weight of the selected items does not exceed a predefined capacity constraint, while the sum of their values is maximized. MCKP is a variant of the classical knapsack problem, incorporating additional constraints to account for the exclusivity of item selection within classes. In the context of the present embodiments, the finite set of items represents the possible bitwidth values that can be assigned to each neural network layer, where each bitwidth option has an associated “weight” (its contribution to the overall model size or computational cost) and “value” (its impact on model accuracy). The layers of the neural network represent the mutually exclusive classes, as each layer must be assigned exactly one bitwidth value, and the deployment constraints (such as total storage size or computational operations limit) serve as the predefined capacity constraint that cannot be exceeded.

For example, when quantizing weights, each layer can be assigned different bitwidth options like 2 bits (allowing 4 values), 8 bits (allowing 256 values), or other options, with the goal of selecting the optimal bitwidth for each layer that maximizes model performance while keeping the total resource usage within the specified constraints.

This process first computes quantization errors for different bitwidth options for each layer independently, then solves a global optimization problem to select the optimal combination of bitwidths across all layers. By treating each layer independently during error computation but optimizing globally for bitwidth selection, the system can identify the most efficient compression strategy for each layer while ensuring overall model optimization.

The iterative nature of the optimization process, alternating between learning and compression phases, allows the system to converge on a solution that maintains task performance while satisfying deployment constraints. This approach provides significant advantages over traditional methods by enabling fine-grained control over the trade-off between model performance and resource utilization at each layer. The system's ability to handle various deployment constraints, including storage size, computational operations, and latency targets, provides unprecedented flexibility in optimizing neural network models for different deployment scenarios and device capabilities. By allowing for layer-specific optimization while maintaining global performance constraints, the system achieves superior compression results compared to uniform quantization approaches, enabling the deployment of sophisticated neural networks on resource-constrained devices without sacrificing essential functionality. Other aspects and advantages of the various embodiments will be readily apparent from the detailed description of the several figures that follows.

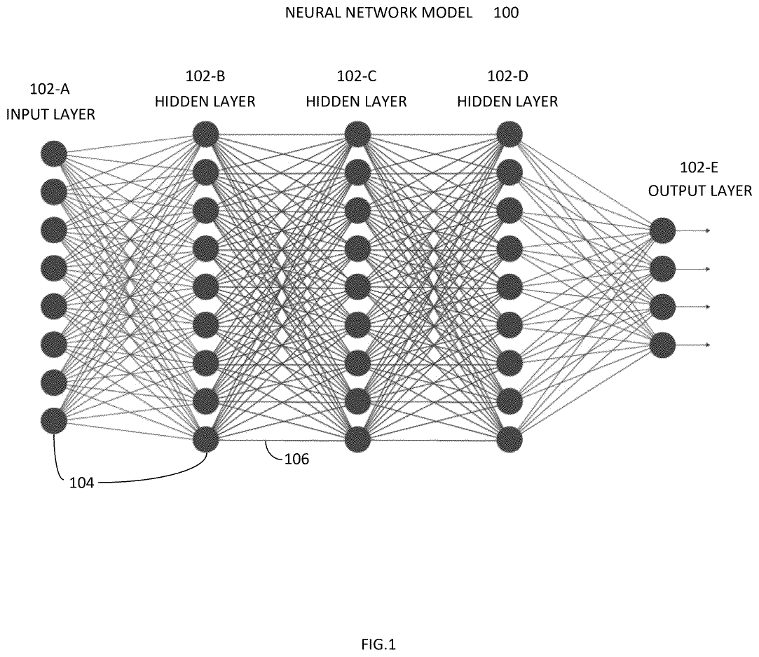

FIG. 1 is a diagram illustrating a neural network model architecture showing multiple layers including an input layer 102-A, hidden layers 102-B, 102-C and 102D, and an output layer 102-F, with interconnecting 106 weights 104 between the layers, consistent with some embodiments. The neural network model 100 comprises a layered architecture designed for processing input data through multiple stages of computation. The input layer 102-A serves as the entry point for data into the network, where raw input features are initially processed. This layer connects to the first hidden layer 102-B through a set of weights 104, where each weight represents a learned parameter that will be subject to quantization during the optimization process.

The hidden layers 102-B through 102-D form the core processing components of the neural network, where each layer progressively extracts and processes higher-level features from the data. The connections between these layers, represented by weights 106, traditionally use high-precision floating-point representations (FP16/FP32) that contribute significantly to the model's storage requirements. During optimization, these weights can be independently quantized to different bitwidth values-for example, from 1 bit (allowing 2 values) up to 8 bits (allowing 256 values) or more, depending on each layer's specific role and sensitivity in maintaining model performance.

The output layer 102-F produces the final computational results of the neural network. The weights connecting to this layer may require different levels of precision compared to earlier layers, as they directly influence the model's output accuracy. The optimization process considers this by potentially allocating different bitwidth values to these final layer connections.

While the illustrated embodiment shows three hidden layers, the architecture is extensible to accommodate additional layers or alternative arrangements. The number of nodes within each layer may vary based on the specific application requirements, and the connections between layers may implement different architectural patterns such as skip connections or attention mechanisms.

Each layer's weights are stored in memory using their respective quantized representations, determined through the multiple-choice knapsack optimization process. This process creates a codebook for each layer containing the representative weight values and corresponding index values that map the original weights to their quantized versions. The optimization ensures that the selected bitwidth allocation across all layers satisfies the specified deployment constraints while maintaining the model's essential functionality.

The quantization process operates independently on each layer's weights while considering the global impact on model performance. This layer-specific approach allows the optimization to account for varying sensitivities across different parts of the network, potentially assigning higher precision to critical layers while more aggressively compressing less sensitive ones.

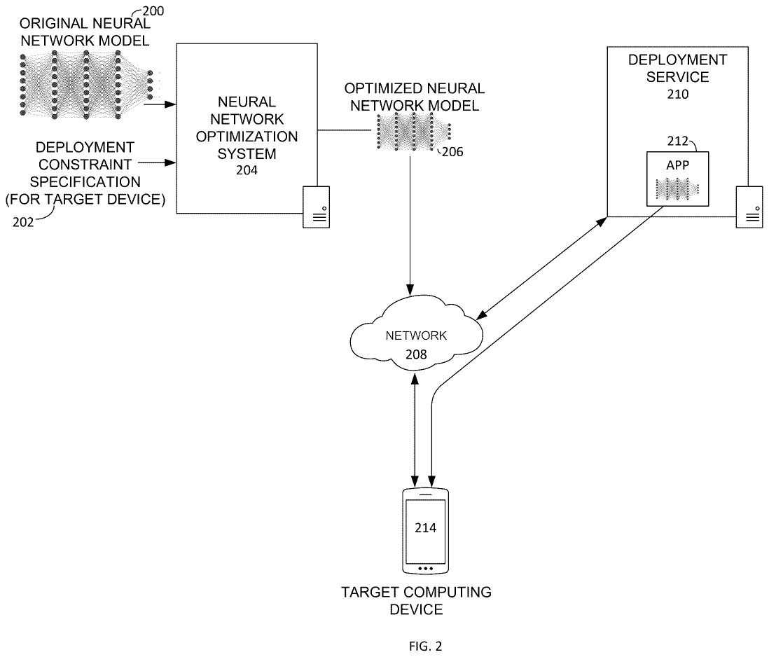

FIG. 2 is a system diagram depicting the flow of a neural network model through an optimization process, showing an original neural network model 200 and deployment constraints 202 being input to a neural network optimization system 204, which outputs an optimized model 206 for deployment through a deployment service 210 to a target computing device 214, consistent with some embodiments.

The neural network optimization system 204 receives two primary inputs: an original neural network model 200 and a deployment constraint specification 202 for the target computing device 214. The original neural network model 200 comprises multiple layers with corresponding weight parameters typically represented in high-precision floating-point format (FP16/FP32). The deployment constraint specification 202 defines the resource limitations of the target device 214, which may include storage size limits, computational operation limits, or end-to-end latency targets.

These inputs are provided to the neural network optimization system 204, which processes the original model 200 according to the specified constraints 202 to produce an optimized neural network model 206. The optimized model 206 maintains the essential functionality of the original model 200 while satisfying the deployment constraints 202 through layer-specific quantization of the model weights.

The optimized neural network model 206 is then transmitted over a network 208 to a deployment service 210. The deployment service 210 packages the optimized model into an application 212 suitable for deployment to the target computing device. This packaging process integrates the optimized neural network model with necessary application code and resources to create a deployable application package.

The packaged application 212 containing the optimized neural network model is then provided to the target computing device 214. The target computing device 214 may be any resource-constrained device, such as a mobile phone, wearable computing device (e.g., augmented reality glasses), or other edge device. Once deployed, the optimized neural network model is loaded into the device's memory and can be used for various implementations, such as image recognition, natural language processing, or other machine learning tasks, while operating within the device's resource constraints.

The deployment service 210 may handle various deployment scenarios and device types, enabling the optimized neural network model to be distributed to different target devices while ensuring compatibility with their specific resource constraints and operational requirements.

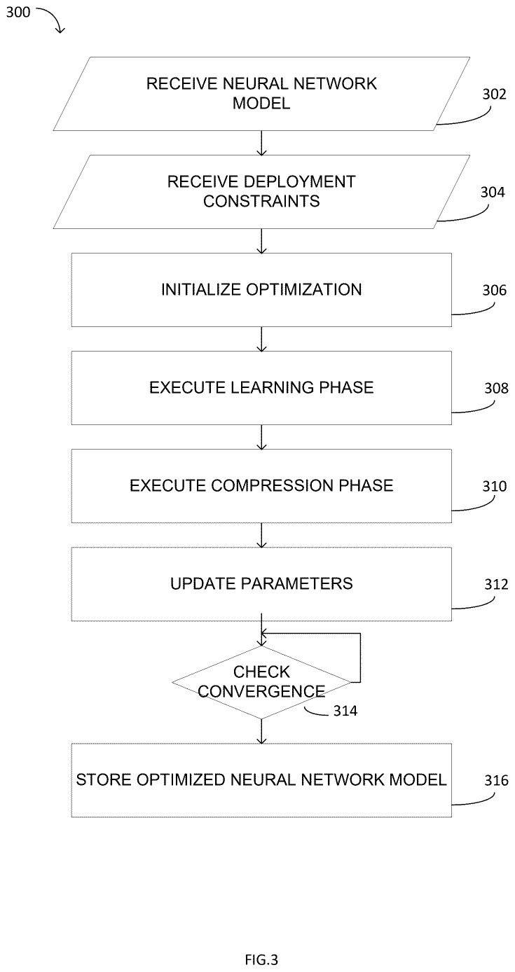

FIG. 3 illustrates a method 300 for optimizing a neural network model through an iterative process of learning and compression phases. The method can be performed by one or more processors of a computer system. The method begins at step 302 by receiving an original neural network model comprising multiple layers with corresponding weight parameters. These weights are typically represented in high-precision floating-point format (FP16/FP32) to enable precise calculations during model operation. At step 304, the method receives deployment constraints that specify resource limitations for the target computing device, which may include storage size limits, computational operation bounds, or end-to-end latency targets.

The initialization process, shown at step 306, prepares the system for optimization through two key operations. First, the system creates duplicate variables by copying the weight parameters for each neural network layer, establishing initial equality between original weights and their duplicates. This relationship can be expressed mathematically as, Wl=Θl, for each layer, l, Where, Wl, represents the original weights and, Θl, represents the duplicate variables for layer, l. Second, the system initializes a penalty parameter, μ with a small value, which will be used to control how strictly the optimization enforces the relationship between original and quantized weights.

The learning phase, depicted at step 308, updates the neural network weights by minimizing a combined objective function that accounts for both task performance and quantization accuracy. This optimization problem can be expressed mathematically as, min W£(W)+μ/2Σ|Wl−Θl|², where £(W) represents the task-specific loss function measuring model performance, and the second term penalizes differences between original weights and their quantized versions. The parameter μ controls the strength of this penalty term.

The compression phase, shown at step 310, determines optimal bitwidth allocations through a two-stage process. First, the system computes quantization errors for different bitwidth options for each layer independently by solving:

$$min \vert Wl - Θ l \vert$$

$$s . t . Θ l = Dq ( Cl , Il )$$

$$\vert Cl \vert = bi$$

where Dq represents the dequantization operation, Cl is the codebook containing representative weight values, Il are index values mapping weights to codebook entries, and bi represents the candidate bitwidth. The system then solves a global optimization problem to select optimal bitwidths across all layers while satisfying deployment constraints:

$$min Σ zil COST ( bi , l )$$

$$s . t . Σ zil = 1 ∀ l$$

$$Σ zil METRIC ( Cl , Il ) \leq T$$

where zil represents binary selection variables for bitwidth choices, COST(bi, l) represents the quantization error for bitwidth bi in layer l, and T represents the deployment constraint target.

At step 312, the system increases the penalty parameter μ by a multiplicative factor to gradually enforce stricter quantization. Step 314 checks for convergence by evaluating whether the difference between weight parameters and their quantized versions has reached a specified threshold. Once convergence is achieved, step 316 stores the optimized neural network model with its quantized weights and corresponding bitwidth allocations, producing a final model that maintains essential functionality while satisfying all specified deployment constraints through layer-specific quantization.

### Software Architecture

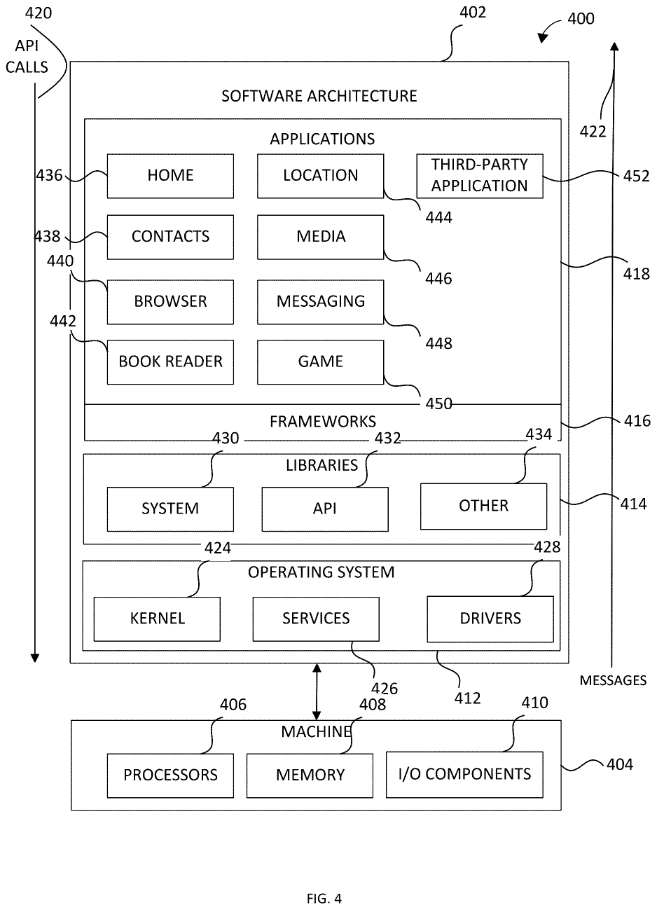

FIG. 4 is a block diagram 400 illustrating a software architecture 402, which can be installed on any one or more of the devices described herein. The software architecture 402 is supported by hardware such as a machine 404 that includes processors 406, memory 408, and I/O components 410. In this example, the software architecture 402 can be conceptualized as a stack of layers, where each layer provides a particular functionality. The software architecture 402 includes layers such as an operating system 412, libraries 414, frameworks 416, and applications 418. Operationally, the applications 418 invoke API calls 420 through the software stack and receive messages 422 in response to the API calls 420.

The operating system 412 manages hardware resources and provides common services. The operating system 412 includes, for example, a kernel 424, services 426, and drivers 428. The kernel 424 acts as an abstraction layer between the hardware and the other software layers. For example, the kernel 424 provides memory management, processor management (e.g., scheduling), component management, networking, and security settings, among other functionalities. The services 426 can provide other common services for the other software layers. The drivers 428 are responsible for controlling or interfacing with the underlying hardware. For instance, the drivers 628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 414 provide a common low-level infrastructure used by the applications 418. The libraries 414 can include system libraries 430 (e.g., C standard library) that provide functions such as memory allocation functions, string manipulation functions, mathematical functions, and the like. In addition, the libraries 414 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 414 can also include a wide variety of other libraries 434 to provide many other APIs to the applications 418.

The frameworks 416 provide a common high-level infrastructure that is used by the applications 418. For example, the frameworks 416 provide various graphical user interface (GUI) functions, high-level resource management, and high-level location services. The frameworks 416 can provide a broad spectrum of other APIs that can be used by the applications 418, some of which may be specific to a particular operating system or platform.

In an example, the applications 418 may include a home application 436, a contacts application 438, a browser application 440, a book reader application 442, a location application 444, a media application 446, a messaging application 448, a game application 450, and a broad assortment of other applications such as a third-party application 452. The applications 418 are programs that execute functions defined in the programs. Various programming languages can be employed to create one or more of the applications 418, structured in a variety of manners, such as object-oriented programming languages (e.g., Objective-C, Java, or C++) or procedural programming languages (e.g., C or assembly language). In a specific example, the third-party application 452 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 452 can invoke the API calls 420 provided by the operating system 412 to facilitate functionalities described herein.

### Machine Architecture

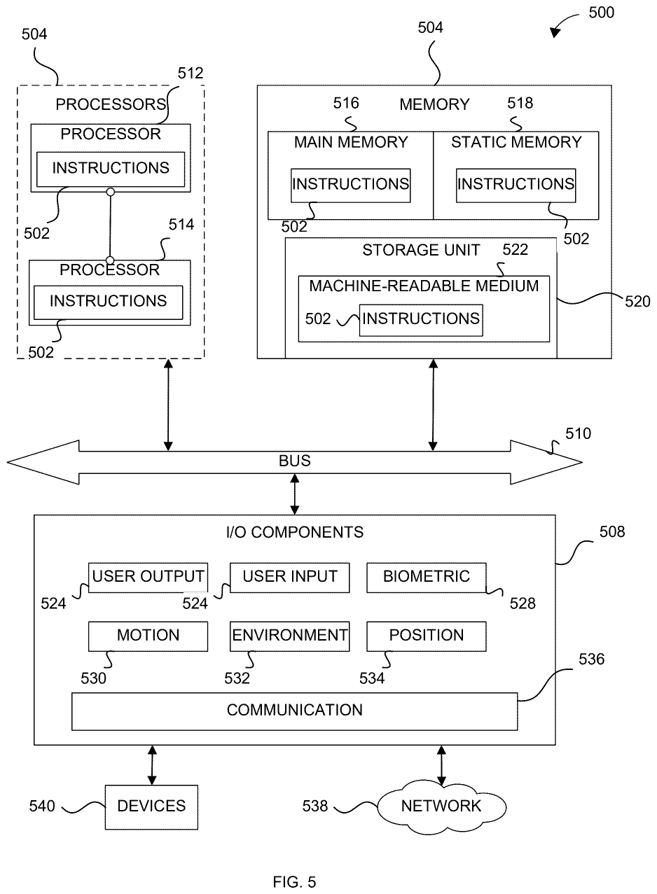

FIG. 5 is a diagrammatic representation of the machine 500 within which instructions 502 (e.g., software, a program, an application, an applet, an app, or other executable code) for causing the machine 500 to perform any one or more of the methodologies discussed herein may be executed. For example, the instructions 502 may cause the machine 500 to execute any one or more of the methods described herein. The instructions 502 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term 6machine” shall also be taken to include a collection of machines that individually or jointly execute the instructions 502 to perform any one or more of the methodologies discussed herein. The machine 500, for example, may comprise the user system 102 or any one of multiple server devices forming part of the server system 110. In some examples, the machine 500 may also comprise both client and server systems, with certain operations of a particular method or algorithm being performed on the server-side and with certain operations of the method or algorithm being performed on the client-side.

The machine 500 may include processors 504, memory 50, and input/output I/O components 508, which may be configured to communicate with each other via a bus 510.

The memory 506 includes a main memory 516, a static memory 518, and a storage unit 520, both accessible to the processors 504 via the bus 510. The main memory 506, the static memory 518, and storage unit 520 store the instructions 502 embodying any one or more of the methodologies or functions described herein. The instructions 502 may also reside, completely or partially, within the main memory 516, within the static memory 518, within machine-readable medium 522 within the storage unit 520, within at least one of the processors 504 (e.g., within the processor's cache memory), or any suitable combination thereof, during execution thereof by the machine 500.

The I/O components 508 may include a wide variety of components to receive input, provide output, produce output, transmit information, exchange information, capture measurements, and so on. The specific I/O components 508 that are included in a particular machine will depend on the type of machine. For example, portable machines such as mobile phones may include a touch input device or other such input mechanisms, while a headless server machine will likely not include such a touch input device. It will be appreciated that the I/O components 508 may include many other components that are not shown in FIG. 5. In various examples, the I/O components 508 may include user output components 524 and user input components 526. The user output components 524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 530 include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 508 further include communication components 536 operable to couple the machine 500 to a network 538 or devices 540 via respective coupling or connections. For example, the communication components 536 may include a network interface component or another suitable device to interface with the network 538. In further examples, the communication components 536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 may be another machine or any of a wide variety of peripheral devices (e.g., a peripheral device coupled via a USB).

Moreover, the communication components 536 may detect identifiers or include components operable to detect identifiers. For example, the communication components 536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 536, such as location via Internet Protocol (IP) geolocation, location via Wi-Fi® signal triangulation, location via detecting an NFC beacon signal that may indicate a particular location, and so forth.

The various memories (e.g., main memory 516, static memory 518, and memory of the processors 504) and storage unit 520 may store one or more sets of instructions and data structures (e.g., software) embodying or used by any one or more of the methodologies or functions described herein. These instructions (e.g., the instructions 502), when executed by processors 504, cause various operations to implement the disclosed examples.

The instructions 502 may be transmitted or received over the network 538, using a transmission medium, via a network interface device (e.g., a network interface component included in the communication components 536) and using any one of several well-known transfer protocols (e.g., hypertext transfer protocol (HTTP)). Similarly, the instructions 502 may be transmitted or received using a transmission medium via a coupling (e.g., a peer-to-peer coupling) to the devices 540.

### EXAMPLES

Example 1 is a method implemented by one or more processors for optimizing a neural network for deployment to a target computing device, the method comprising: receiving a neural network model comprising multiple layers and corresponding weight parameters; receiving a deployment constraint specification for the target computing device specifying at least one of i) a storage size limit, ii) a computational operations limit, or ii) a latency limit for the neural network model; initializing optimization variables by i) storing a copy of the weight parameters as duplicate variables in memory, and ii) setting an initial penalty parameter value; iteratively optimizing the neural network model by executing a learning phase comprising: updating the weight parameters using a task-specific loss function and the penalty parameter; executing a compression phase comprising: computing, for each layer, quantization errors for multiple bitwidth options; determining an optimal bitwidth allocation across the layers by solving a constrained optimization problem subject to the deployment constraint target; generating quantized weights using the determined optimal bitwidth allocation; increasing the penalty parameter value; repeating the learning and compression phases until convergence criteria are satisfied; and storing the optimized neural network model with the quantized weights and corresponding bitwidth allocations for deployment.

In Example 2, the subject matter of Example 1 includes, wherein determining the optimal bitwidth allocation comprises: computing a quantization cost for each layer by: iterating through a set of candidate bitwidth values for each layer; determining an optimal codebook and index values for each candidate bitwidth; calculating a weight approximation error between original weights and quantized weights for each candidate; solving a multiple-choice knapsack optimization problem using the computed quantization costs to select a bitwidth for each layer while satisfying the deployment constraint target.

In Example 3, the subject matter of Examples 1-2 includes, wherein the deployment constraint target comprises at least one of: a total storage size in bits for storing the quantized neural network model; a total number of floating point operations performed during model inference; an end-to-end latency measurement for model execution.

In Example 4, the subject matter of Examples 1-3 includes, wherein executing the learning phase comprises: computing a task-specific loss function based on a training dataset; computing a penalty term based on differences between the weight parameters and duplicate variables; updating the weight parameters using an optimization algorithm while minimizing the combined task-specific loss function and penalty term.

In Example 5, the subject matter of Examples 1-4 includes, wherein generating quantized weights comprises: creating a codebook containing representative weight values for each layer; generating index values that map original weights to codebook entries; applying a dequantization operation using the codebook and index values to restore approximate weight values.

In Example 6, the subject matter of Examples 1-5 includes, initializing the weight parameters using values from a reference model; setting an initial penalty parameter to a small value; incrementing the penalty parameter by a multiplicative factor during each iteration; determining convergence based on a difference between weight parameters and duplicate variables reaching a threshold.

In Example 7, the subject matter of Examples 1-6 includes, wherein the deployment constraint specification comprises at least one of: a total storage size limit for the neural network model; a total number of floating point operations limit for model inference; or an end-to-end latency measurement limit for model execution on the target computing device; wherein the optimization process simultaneously satisfies all specified deployment constraints while maximizing model performance.

Example 8 is a system for optimizing a neural network for deployment to a target computing device, the system comprising: at least one processor; at least one memory storage device storing instructions thereon, which, when executed by the at least one processor, cause the system to perform operations comprising: receiving a neural network model comprising multiple layers and corresponding weight parameters; receiving a deployment constraint specification for the target computing device specifying at least one of i) a storage size limit, ii) a computational operations limit, or ii) a latency limit for the neural network model; initializing optimization variables by i) storing a copy of the weight parameters as duplicate variables in memory, and ii) setting an initial penalty parameter value; iteratively optimizing the neural network model by executing a learning phase comprising: updating the weight parameters using a task-specific loss function and the penalty parameter; executing a compression phase comprising: computing, for each layer, quantization errors for multiple bitwidth options; determining an optimal bitwidth allocation across the layers by solving a constrained optimization problem subject to the deployment constraint target; generating quantized weights using the determined optimal bitwidth allocation; increasing the penalty parameter value; repeating the learning and compression phases until convergence criteria are satisfied; and storing the optimized neural network model with the quantized weights and corresponding bitwidth allocations for deployment.

In Example 9, the subject matter of Example 8 includes, wherein determining the optimal bitwidth allocation comprises: computing a quantization cost for each layer by: iterating through a set of candidate bitwidth values for each layer; determining an optimal codebook and index values for each candidate bitwidth; calculating a weight approximation error between original weights and quantized weights for each candidate; solving a multiple-choice knapsack optimization problem using the computed quantization costs to select a bitwidth for each layer while satisfying the deployment constraint target.

In Example 10, the subject matter of Examples 8-9 includes, wherein the deployment constraint target comprises at least one of: a total storage size in bits for storing the quantized neural network model; a total number of floating point operations performed during model inference; an end-to-end latency measurement for model execution.

In Example 11, the subject matter of Examples 8-10 includes, wherein executing the learning phase comprises: computing a task-specific loss function based on a training dataset; computing a penalty term based on differences between the weight parameters and duplicate variables; updating the weight parameters using an optimization algorithm while minimizing the combined task-specific loss function and penalty term.

In Example 12, the subject matter of Examples 8-11 includes, wherein generating quantized weights comprises: creating a codebook containing representative weight values for each layer; generating index values that map original weights to codebook entries; applying a dequantization operation using the codebook and index values to restore approximate weight values.

In Example 13, the subject matter of Examples 8-12 includes, initializing the weight parameters using values from a reference model; setting an initial penalty parameter to a small value; incrementing the penalty parameter by a multiplicative factor during each iteration; determining convergence based on a difference between weight parameters and duplicate variables reaching a threshold.

In Example 14, the subject matter of Examples 8-13 includes, wherein the deployment constraint specification comprises at least one of: a total storage size limit for the neural network model; a total number of floating point operations limit for model inference; or an end-to-end latency measurement limit for model execution on the target computing device; wherein the optimization process simultaneously satisfies all specified deployment constraints while maximizing model performance.

Example 15 is a memory storage device storing instructions thereon, which, when executed by the at least one processor, cause the system to perform operations comprising: receiving a neural network model comprising multiple layers and corresponding weight parameters; receiving a deployment constraint specification for the target computing device specifying at least one of i) a storage size limit, ii) a computational operations limit, or ii) a latency limit for the neural network model; initializing optimization variables by i) storing a copy of the weight parameters as duplicate variables in memory, and ii) setting an initial penalty parameter value; iteratively optimizing the neural network model by executing a learning phase comprising: updating the weight parameters using a task-specific loss function and the penalty parameter; executing a compression phase comprising: computing, for each layer, quantization errors for multiple bitwidth options; determining an optimal bitwidth allocation across the layers by solving a constrained optimization problem subject to the deployment constraint target; generating quantized weights using the determined optimal bitwidth allocation; increasing the penalty parameter value; repeating the learning and compression phases until convergence criteria are satisfied; and storing the optimized neural network model with the quantized weights and corresponding bitwidth allocations for deployment.

In Example 15, the subject matter of Example 15 includes, wherein determining the optimal bitwidth allocation comprises: computing a quantization cost for each layer by: iterating through a set of candidate bitwidth values for each layer; determining an optimal codebook and index values for each candidate bitwidth; calculating a weight approximation error between original weights and quantized weights for each candidate; solving a multiple-choice knapsack optimization problem using the computed quantization costs to select a bitwidth for each layer while satisfying the deployment constraint target.

In Example 17, the subject matter of Examples 15 -15 includes, wherein the deployment constraint target comprises at least one of: a total storage size in bits for storing the quantized neural network model; a total number of floating point operations performed during model inference; an end-to-end latency measurement for model execution.

In Example 18, the subject matter of Examples 15-17 includes, wherein executing the learning phase comprises: computing a task-specific loss function based on a training dataset; computing a penalty term based on differences between the weight parameters and duplicate variables; updating the weight parameters using an optimization algorithm while minimizing the combined task-specific loss function and penalty term.

In Example 19, the subject matter of Examples 15-18 includes, wherein generating quantized weights comprises: creating a codebook containing representative weight values for each layer; generating index values that map original weights to codebook entries; applying a dequantization operation using the codebook and index values to restore approximate weight values.

Example 20 is at least one machine-readable medium including instructions that, when executed by processing circuitry, cause the processing circuitry to perform operations to implement of any of Examples 1-19.

Example 21 is an apparatus comprising means to implement of any of Examples 1-19.

Example 22 is a system to implement of any of Examples 1-19.

Example 23 is a method to implement of any of Examples 1-19.

What is claimed is:

1. A method implemented by one or more processors for optimizing a neural network for deployment to a target computing device, the method comprising:
receiving a neural network model comprising multiple layers and corresponding weight parameters;
receiving a deployment constraint specification for the target computing device specifying at least one of i) a storage size limit, ii) a computational operations limit, or ii) a latency limit for the neural network model;
initializing optimization variables by i) storing a copy of the weight parameters as duplicate variables in memory, and ii) setting an initial penalty parameter value;
iteratively optimizing the neural network model by executing a learning phase comprising, updating the weight parameters using a task-specific loss function and the penalty parameter;
executing a compression phase comprising:
computing, for each layer, quantization errors for multiple bitwidth options; and
determining an optimal bitwidth allocation across the layers by solving a constrained optimization problem subject to the deployment constraint target; and
generating quantized weights using the determined optimal bitwidth allocation;
increasing the penalty parameter value;
repeating the learning and compression phases until convergence criteria are satisfied; and
storing the optimized neural network model with the quantized weights and corresponding bitwidth allocations for deployment.

2. The method of claim 1, wherein determining the optimal bitwidth allocation comprises:
computing a quantization cost for each layer by:
iterating through a set of candidate bitwidth values for each layer;
determining an optimal codebook and index values for each candidate bitwidth;
calculating a weight approximation error between original weights and quantized weights for each candidate; and
solving a multiple-choice knapsack optimization problem using the computed quantization costs to select a bitwidth for each layer while satisfying the deployment constraint target.

3. The method of claim 1, wherein the deployment constraint target comprises at least one of:
a total storage size in bits for storing the quantized neural network model;
a total number of floating point operations performed during model inference; and
an end-to-end latency measurement for model execution.

4. The method of claim 1, wherein executing the learning phase comprises:
computing a task-specific loss function based on a training dataset;
computing a penalty term based on differences between the weight parameters and duplicate variables; and
updating the weight parameters using an optimization algorithm while minimizing the combined task-specific loss function and penalty term.

5. The method of claim 1, wherein generating quantized weights comprises:
creating a codebook containing representative weight values for each layer;
generating index values that map original weights to codebook entries; and
applying a dequantization operation using the codebook and index values to restore approximate weight values.

6. The method of claim 1, further comprising:
initializing the weight parameters using values from a reference model;
setting an initial penalty parameter to a small value;
incrementing the penalty parameter by a multiplicative factor during each iteration; and
determining convergence based on a difference between weight parameters and duplicate variables reaching a threshold.

7. The method of claim 1, wherein the deployment constraint specification comprises at least one of:
a total storage size limit for the neural network model;
a total number of floating point operations limit for model inference; or
an end-to-end latency measurement limit for model execution on the target computing device;
wherein the optimization process simultaneously satisfies all specified deployment constraints while maximizing model performance.

8. A system for optimizing a neural network for deployment to a target computing device, the system comprising:
at least one processor;
at least one memory storage device storing instructions thereon, which, when executed by the at least one processor, cause the system to perform operations comprising:
receiving a neural network model comprising multiple layers and corresponding weight parameters;
receiving a deployment constraint specification for the target computing device specifying at least one of i) a storage size limit, ii) a computational operations limit, or ii) a latency limit for the neural network model;
initializing optimization variables by i) storing a copy of the weight parameters as duplicate variables in memory, and ii) setting an initial penalty parameter value;
iteratively optimizing the neural network model by executing a learning phase comprising:
updating the weight parameters using a task-specific loss function and the penalty parameter;
executing a compression phase comprising:
computing, for each layer, quantization errors for multiple bitwidth options; and
determining an optimal bitwidth allocation across the layers by solving a constrained optimization problem subject to the deployment constraint target; and
generating quantized weights using the determined optimal bitwidth allocation;
increasing the penalty parameter value;
repeating the learning and compression phases until convergence criteria are satisfied; and
storing the optimized neural network model with the quantized weights and corresponding bitwidth allocations for deployment.

9. The system of claim 8, wherein determining the optimal bitwidth allocation comprises:
computing a quantization cost for each layer by:
iterating through a set of candidate bitwidth values for each layer;
determining an optimal codebook and index values for each candidate bitwidth;
calculating a weight approximation error between original weights and quantized weights for each candidate; and
solving a multiple-choice knapsack optimization problem using the computed quantization costs to select a bitwidth for each layer while satisfying the deployment constraint target.

10. The system of claim 8, wherein the deployment constraint target comprises at least one of:
a total storage size in bits for storing the quantized neural network model;
a total number of floating point operations performed during model inference; and
an end-to-end latency measurement for model execution.

11. The system of claim 8, wherein executing the learning phase comprises:
computing a task-specific loss function based on a training dataset;
computing a penalty term based on differences between the weight parameters and duplicate variables; and
updating the weight parameters using an optimization algorithm while minimizing the combined task-specific loss function and penalty term.

12. The system of claim 8, wherein generating quantized weights comprises:
creating a codebook containing representative weight values for each layer;
generating index values that map original weights to codebook entries; and
applying a dequantization operation using the codebook and index values to restore approximate weight values.

13. The system of claim 8, further comprising:
initializing the weight parameters using values from a reference model;
setting an initial penalty parameter to a small value;
incrementing the penalty parameter by a multiplicative factor during each iteration; and
determining convergence based on a difference between weight parameters and duplicate variables reaching a threshold.

14. The system of claim 8, wherein the deployment constraint specification comprises at least one of:
a total storage size limit for the neural network model;
a total number of floating point operations limit for model inference; or
an end-to-end latency measurement limit for model execution on the target computing device;
wherein the optimization process simultaneously satisfies all specified deployment constraints while maximizing model performance.

15. A memory storage device storing instructions thereon, which, when executed by at least one processor, cause a system to perform operations comprising:
receiving a neural network model comprising multiple layers and corresponding weight parameters;
receiving a deployment constraint specification for a target computing device specifying at least one of i) a storage size limit, ii) a computational operations limit, or ii) a latency limit for the neural network model;
initializing optimization variables by i) storing a copy of the weight parameters as duplicate variables in memory, and ii) setting an initial penalty parameter value;
iteratively optimizing the neural network model by executing a learning phase comprising:
updating the weight parameters using a task-specific loss function and the penalty parameter;
executing a compression phase comprising:
computing, for each layer, quantization errors for multiple bitwidth options; and
determining an optimal bitwidth allocation across the layers by solving a constrained optimization problem subject to the deployment constraint target; and
generating quantized weights using the determined optimal bitwidth allocation;
increasing the penalty parameter value;
repeating the learning and compression phases until convergence criteria are satisfied; and
storing the optimized neural network model with the quantized weights and corresponding bitwidth allocations for deployment.

16. The memory storage device of claim 15, wherein determining the optimal bitwidth allocation comprises:
computing a quantization cost for each layer by:
iterating through a set of candidate bitwidth values for each layer;
determining an optimal codebook and index values for each candidate bitwidth;
calculating a weight approximation error between original weights and quantized weights for each candidate; and
solving a multiple-choice knapsack optimization problem using the computed quantization costs to select a bitwidth for each layer while satisfying the deployment constraint target.

17. The memory storage device of claim 15, wherein the deployment constraint target comprises at least one of:
a total storage size in bits for storing the quantized neural network model;
a total number of floating point operations performed during model inference; and
an end-to-end latency measurement for model execution.

18. The memory storage device of claim 16, wherein executing the learning phase comprises:
computing a task-specific loss function based on a training dataset;
computing a penalty term based on differences between the weight parameters and duplicate variables; and
updating the weight parameters using an optimization algorithm while minimizing the combined task-specific loss function and penalty term.

19. The memory storage device of claim 16, wherein generating quantized weights comprises:
creating a codebook containing representative weight values for each layer;
generating index values that map original weights to codebook entries; and
applying a dequantization operation using the codebook and index values to restore approximate weight values.

20. The memory storage device of claim 16, wherein the deployment constraint specification comprises at least one of:
a total storage size limit for the neural network model;
a total number of floating point operations limit for model inference; or
an end-to-end latency measurement limit for model execution on the target computing device;
wherein the optimization process simultaneously satisfies all specified deployment constraints while maximizing model performance.
